(19) United States
(12) Patent Application Publication
(10) Pub. No.: US 2005/0213074 A1
(43) Pub. Date: Sep. 29, 2005

(54) Radar device

(76) Inventor: Yoshiaki Hoashi, Kariya-city (JP)

Correspondence Address: HARNESS, DICKEY & PIERCE, P.L.C., P.O. BOX 828, BLOOMFIELD HILLS, MI, 48303, US

(21) Appl. No.: 11/087,974

(22) Filed: Mar. 23, 2005

(30) Foreign Application Priority Data
Mar. 25, 2004 (JP) 2004-089164

(51) Int. Cl. G01C 3/08; G01S 13/00; G01B 9/02

(52) U.S. Cl. 356/4.09; 356/450; 356/4.07

(57) ABSTRACT

A laser radar sensor includes a photoreceptor, a dummy circuit, an amplifier, a selector, and the first and the second detection circuits. A photoreception signal outputted from the photoreceptor and an output signal of the dummy circuit are amplified by the amplifier, and inputted to the second detection circuit. A noise component included in the photoreception signal based on the output signal of the dummy circuit when distance detection is not performed. The distance detection is performed based on the reception signal from which the noise component is removed. As a result, a reduction in detectable distance of the laser radar sensor is less likely to occur. Furthermore, the noise component is detected using the dummy circuit and the selector. Thus, the consideration of the predetermined rotation angle is not required in optical system design and limiting factors in the optical system design can be reduced.

### CROSS REFERENCE TO RELATED APPLICATION

This application is based on and incorporates herein by reference Japanese Patent Application No. 2004-89164 filed on Mar. 25, 2004.

### FIELD OF THE INVENTION

The present invention relates to a radar device.

### BACKGROUND OF THE INVENTION

A vehicular radar device that detects an object ahead of a vehicle is proposed in JP-A-2002-40139. The radar device emits light waves or millimeter waves forward and detects an object based on reflected waves. This kind of radar device is used in a warning system that provides a warning when the vehicle becomes close to an object in front, such as a vehicle in front. It is also used in a speed control system that controls a vehicle speed to maintain a predetermined distance to a vehicle in front.

In the radar device, a laser diode emits laser beams as outgoing waves. The laser beams are reflected with a rotating polygon mirror. Multiple laser beams are emitted in a predetermined range with predetermined horizontal and vertical limits. The laser beams reflected by an object are received by the radar device through a light sensitive lens. The received reflected beams are guided to a light sensitive element. The light sensitive element outputs an electrical signal indicating light levels. The radar device determines a distance to the object based on the time when the electrical signal reaches a predetermined voltage after the laser beam is emitted. It also determines horizontal and vertical positions of the object based on an emission angle of the laser beam.

The radar device detects a distance to a vehicle in front and a speed of the vehicle in front. The reflected light level is lowered when a rear surface of the vehicle is covered with dirt or snow. In such a case, a reception signal component having a level that corresponds to the reflected light level is not easily distinguished from a noise component produced by various factors. As a result, performance of the radar device decreases.

To solve this problem, another radar device is proposed in JP-A-2004-177350. The radar device determines a noise component based on a reception signal outputted when a polygon mirror is at a predetermined rotation angle at which laser beams are not outputted to the outside. Such reception signal only contains a noise component. However, the consideration of the predetermined rotation angle is required in optical system design and it is a large limiting factor in the optical system design.

### SUMMARY OF THE INVENTION

The present invention therefore has an objective to provide a radar device that properly detects an object even when a level of reflected light from the object is low with small limitations in optical system design. A radar device of the present invention includes reflected wave receiving means, a reception signal an output section, a noise component signal output section, and a selector section. The reflected wave receiving means receives reflected light from objects. The reception signal output section outputs a reception signal including a reception signal component corresponding to the intensity of the reflected light. The noise component signal output section outputs a noise component signal including only noise component. The selector section selects either one of the reception signal and the noise component signal as an input signal to a detection means.

The radar device also includes noise calculation means and noise component removing means. The noise calculation means calculates the noise component based on the reception signal when the noise component signal is selected by the selector section. The noise component removing means removes the noise component from the reception signal when the reception signal is selected by the selector section.

With this configuration, an object detectable distance range of the radar device is less likely to be reduced. Moreover, the noise component is detected using the noise component signal output section and the selector section. Thus, the consideration of the predetermined rotation angle is not required in optical system design unlike the prior art and limiting factors in the optical system design can be reduced.

### BRIEF DESCRIPTION OF THE DRAWINGS

The above and other objectives, features and advantages of the present invention will become more apparent from the following detailed description made with reference to the accompanying drawings. In the drawings:

FIG. 1 is a block diagram of a vehicular control system in which a laser radar sensor is installed according to the first embodiment of the present invention;

FIG. 2A is a block diagram of the radar sensor according to the first embodiment;

FIG. 2B is a block diagram of the first detection circuit included in the radar sensor according to the first embodiment;

FIG. 2C is a block diagram of the second detection circuit included in the radar sensor according to the first embodiment;

FIG. 3 is a perspective view of the radar sensor and its scan area according to the first embodiment;

FIG. 4A is an explanatory diagram for explaining principals of distance detection according to the first embodiment;

FIG. 4B is an explanatory diagram for explaining a method for calculating a peak value of a photoreception signal according to the first embodiment;

FIG. 5 is an explanatory diagram for explaining a process of analog to digital conversion performed in a analog-to-digital conversion circuit of the second detection circuit according to the first embodiment;

FIG. 6 is an explanatory diagram for explaining a method for setting the number of photoreception signals to be summed according to the first embodiment;

FIG. 7 is an explanatory diagram for explaining a process for shifting a data range of the photoreception signals to be summed by the second detection circuit according to the first embodiment;

FIG. 8A is an explanatory diagram for showing relationships between a photoreception signal component and a noise component of a summation signal according to the first embodiment;

FIG. 8B is an explanatory diagram for explaining principles of distance detection based on the summation signal;

FIG. 9 is an explanatory diagram showing a linear interpolation process performed by the second detection circuit according to the first embodiment;

FIG. 10 is a block diagram of a vehicular control system in which a laser radar sensor is installed according to the second embodiment of the present invention;

FIG. 11 is a block diagram of a vehicular control system in which a laser radar sensor is installed according to the third embodiment of the present invention; and

FIG. 12 is a block diagram of a vehicular control system in which a laser radar sensor is installed according to the fourth embodiment of the present invention.

### DETAILED DESCRIPTION OF THE PREFERRED EMBODIMENT

The preferred embodiments of the present invention will be explained with reference to the accompanying drawings. In the drawings, the same numerals are used for the same components and devices.

### First Embodiment

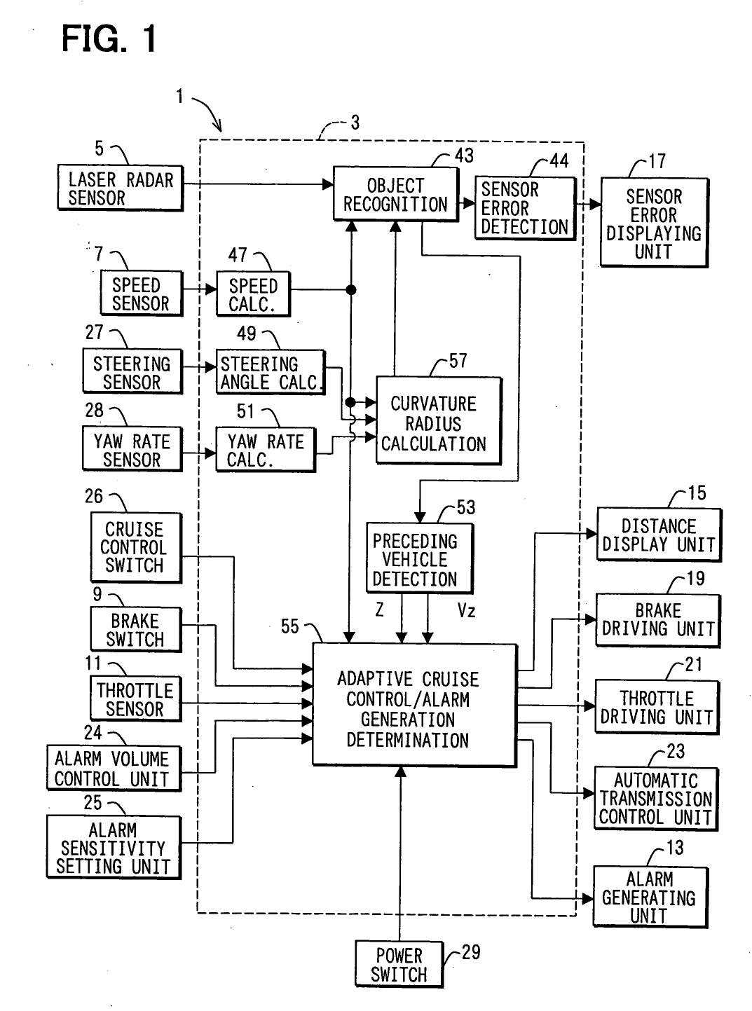

Referring to FIG. 1, a vehicle control system 1 includes an object recognition and cruise control electronic control unit (ECU) 3. The ECU 3 has a microcomputer as a main component, and has an input and output interface (I/O) and various driving and detection circuits.

The ECU 3 receives signals from a laser radar sensor 5, a speed sensor 7, a brake switch 9, and a throttle sensor 11. The radar sensor 5 is a radar device. The ECU 3 outputs driving signals to an alarm generating unit 13, a distance displaying unit 15, a sensor error displaying unit 17, a brake actuating unit 19, a throttle actuating unit 21, and an automatic transmission control unit 23.

An alarm volume control unit 24, an alarm sensitivity setting unit 25, a cruise control switch 26, a steering sensor 27, and a yaw rate sensor 28 are connected to the ECU 3. The alarm volume control unit 24 controls a volume of an alarm sound. The alarm sensitivity setting unit 25 controls sensitivity in an alarm determination process. The steering sensor 27 detects a variation in a steering wheel angle. The yaw rate sensor 28 detects a yaw rate of a vehicle. The ECU 3 has a power switch 29 and starts control processes when the power switch 29 is turned on.

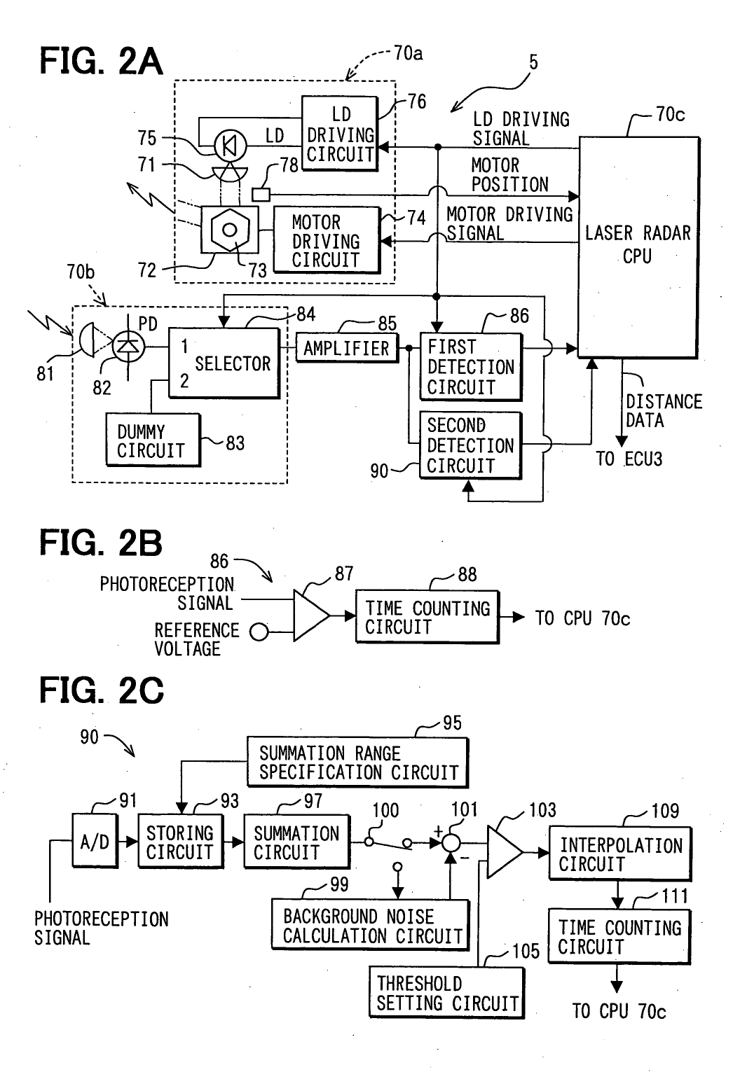

Referring to FIG. 2A, the radar sensor 5 includes a light emitting circuit 70a, a light receiving circuit 70b, and a laser radar CPU 70c. The light emitting circuit 70a, which is an outgoing wave emitting means, has a semiconductor laser diode (LD) 75 that emits laser pulses (outgoing wave) to a predetermined area via a light emitting lens 71 and a scanner 72. The laser diode 75 is connected to the CPU 70c via the laser diode driving circuit 76. The laser diode 75 emits laser beams (outgoing waves) according to driving signals from the CPU 70c. The scanner 72 has a polygon mirror 73 arranged rotatable around its vertical axis. The polygon mirror 73 is rotated by a motor (not shown) when a driving signal is inputted. A rotation position of the motor is detected by a motor rotation position sensor 78 and inputted to the CPU 70c.

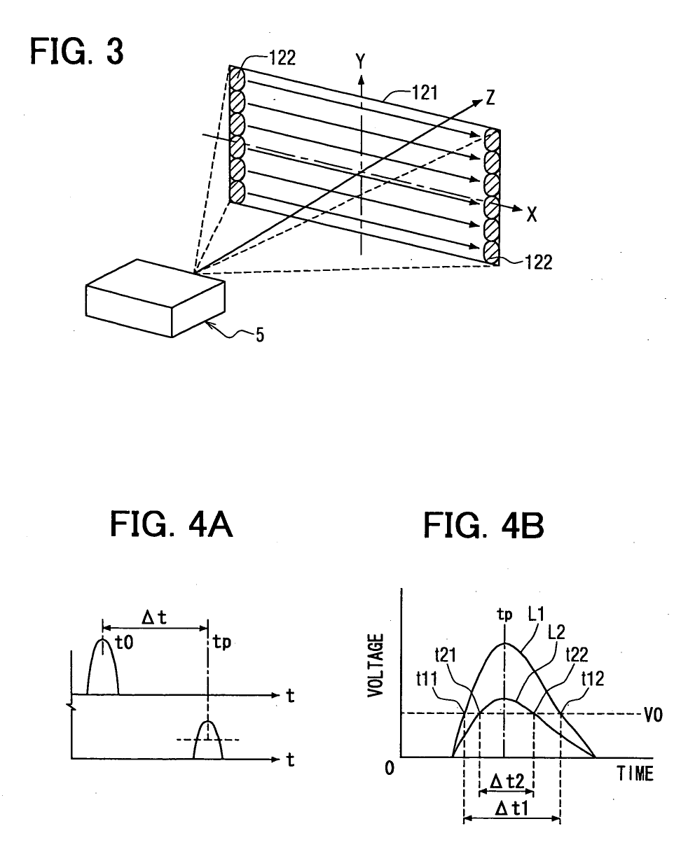

The polygon mirror 73 is formed in a six-sided pyramid-like shape having six mirror faces. The mirror faces are arranged at different angles with respect to its bottom face. Thus, the laser beams are outputted such that an area within predetermined angles in the horizontal and vertical directions is scanned with random laser beams. A method of the scanning will be discussed referring to FIG. 3. FIG. 3 shows laser beam patterns 122 in the case that the laser beams are emitted on right and left edges of a scan area (detection area) 121 and it does not show the patterns in the case that the laser beams are emitted in an area between the edges.

The emitted laser beam patterns 122 are shown substantially in an oval although they may be in a rectangular. Electric waves, such as millimeter waves, or ultra sonic waves can be used instead of the laser beams. The object detection is not limited to the scanning and any other method for determining two points in addition to a distance can be used.

The laser beams are emitted to the scan area 121 in the Z direction such that the X-Y plane is scanned in sequence. The Y-axis is aligned in the reference direction, which is equal to the vertical direction of the vehicle. The X-axis is aligned in the scanning direction, which is the side-to-side direction of the vehicle.

The scan area 121 that is scanned by two-dimensional scanning with the laser beams is defined at 20 degrees (0.08 degrees×451 points) in the X-axis direction and 4 degrees (0.7 degrees×6 lines) in the Y-axis direction. The scan area 121 is scanned from left to right and from top to bottom in FIG. 3. More specifically, a laser beams are emitted to the first scanning line at the uppermost line from left to right 0.08 degrees apart. The laser beams are emitted to the second scanning lines one line below the first scanning line after the first line is scanned. Multiple laser beams are emitted to the third to the six scanning lines in the same manner.

The laser beams are emitted in the scan area 121 and the reflected laser beams are received by the radar sensor 5. Scan angles ,,x and ,,y that indicate emission angles of the laser beams and a distance L are calculated based on the reflected laser beams. The scan angle ,,x is determined as a horizontal scan angle between a line of the laser beam on the X-Z plane and the Z axis. The scan angle ,,y is determined as a vertical scan angle between a line of the laser beam on the Y-Z plane and the Z axis.

The light receiving circuit 70b is a reflected wave receiving means that receives reflected wave of the outgoing wave and outputs a photoreception signal according to intensity of the reflected wave. The light receiving circuit 70b of the radar sensor 5 includes a condenser lens 81, a photoreceptor 82, a dummy circuit 83, and a selector 84. The condenser lens 81 collects the laser beams reflected by an object (not shown). The photoreceptor 82, which is a reception signal output second of the light receiving circuit 70b, receives reflected laser beams and outputs electrical signals (photoreception signals) indicating levels of the received laser beams. The dummy circuit 83, which is a noise component signal output section and constructed of a resistor and a capacitor, has the same impedance as the photoreceptor 82. It outputs noise component signals including only noise components.

The selector 84 selects a circuit to which an amplifier 85 is connected, namely, it selects either one of the reception signal outputted from the photoreceptor 82 and the noise component signal outputted from the dummy circuit 83 as an input signal to the first and the second detection circuit 86, 90. The amplifier 85 is connected in a subsequent stage of the light receiving circuit 70b. Select 1 and select 2 of the selector 84 are connected to the photoreceptor 82 and the dummy circuit 83, respectively.

With this configuration, the connection between the amplifier 85 and the photoreceptor 82, or between the amplifier 85 and the dummy circuit 83 is selected. The photoreception signals are outputted to the amplifier 85 when the selector 84 is set to select 1. The photoreception signals are not outputted and signals containing electromagnetic noises received by the dummy circuit 83 are outputted to the amplifier 85 when the selector 84 is set to select 2.

The selector 84 receives LD driving signals from the CPU 70c for setting select 1 or select 2. Select 1 is set for enabling the execution of the distance detection and select 2 is set for disabling the execution of the distance detection.

The photoreception signals outputted from the photoreceptor 82 and the signals outputted from the dummy circuit 83 are amplified by the amplifier 85 and inputted to the first detection circuit 86 and the second detection circuit 90. The first detection circuit 86 detects an object that is reflecting the laser beams based on the photoreception signals. The second detection circuit 90 sums up the photoreception signals and detects an object that is reflecting the laser beams based on a summation signal. The summation signal is produced based on the summation of the photoreception signals.

Referring to FIG. 2A, the first detection circuit 86 includes a comparator 87 and a time counting circuit 88. The comparator 87 compares each photoreception signal with a reference voltage and outputs a comparison signal to the time counting circuit 88 when the level of the photoreception signal is higher than the reference voltage. The time counting circuit 88 calculates a distance L between the vehicle and the object based on outputs of the comparator 87.

The time counting circuit 88 calculates a time period between the time at which the laser beam is emitted and time at which the laser beam is received. Referring to FIG. 4A, the time period between time t0 at which the laser beam is emitted and time tp at which a peak appears in the photoreception signal is calculated. The LD driving signal outputted form the CPU 70c to the LD driving circuit 76 is inputted to the time counting circuit 88, and the time t0 is detected based on the LD driving signal. Time tp is detected based on the comparison signal. The detection of time tp will be discussed in more detail referring to FIG. 4B.

Rising time (t11, t21) at which the level of the photoreception signal exceeds the reference voltage V0 and falling time (t12, t22) at which the level of the photoreception signal falls below the reference voltage V0 are detected. Time tp is calculated based on the rising time and the falling time. Curves L1, L2 of two photoreception signals produced based on reflected light beams having different levels of intensity are shown in FIG. 4B. The curve marked as L1 corresponds to the reflected light beam having higher intensity and the curve marked as L2 corresponds to the reflected light beam having lower intensity.

The curves L1, L2 are asymmetrical and degrees of asymmetry become higher as the amplitude of the photoreception signals increase. Therefore, the time counting circuit 88 calculates the time period (,,t1, ,,t2) between the rising time (t11, t21), which is a parameter corresponds to the amplitude of the photoreception signal, and the falling time (t12, t22). Then, it calculates time tp based on the rising time (t11, t21) and the falling time (t12, t22) with consideration of the time period (,,t1, ,,t2). Time difference ,,t between time t0 at which the laser beam is emitted and time tp is calculated after the time tp is calculated. The time difference ,,t is coded into a binary digital signal and inputted to the CPU 70c.

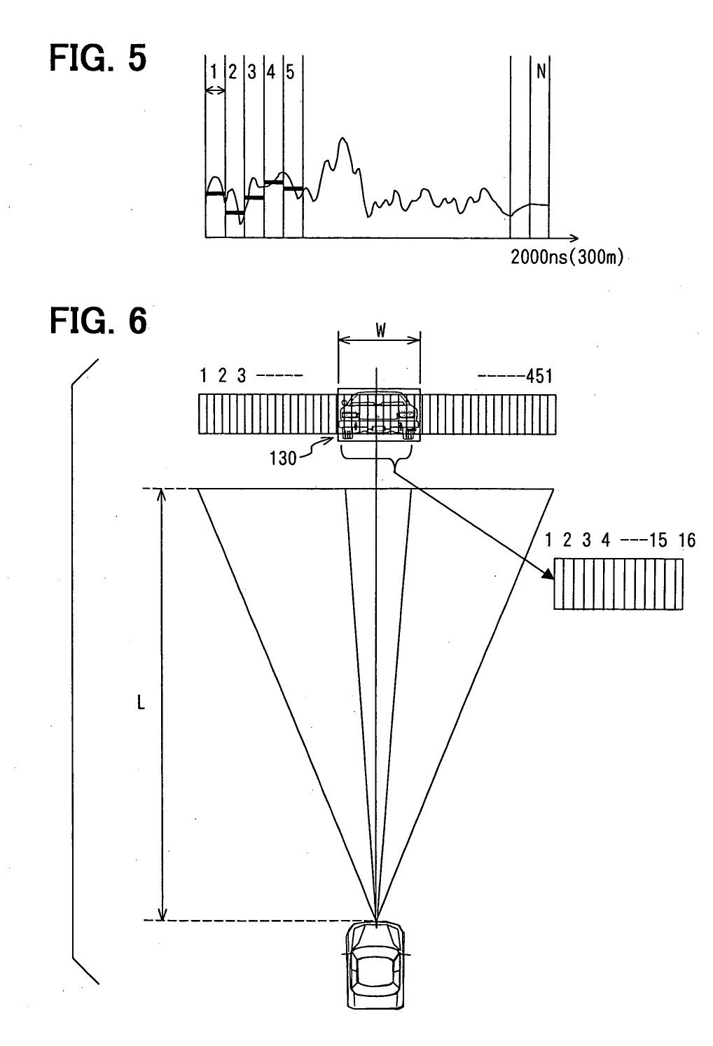

Referring to FIG. 2C, the second detection circuit 90 includes an analog-to-digital (A/D) converter 91. The photoreception signals outputted from the amplifier 85 are inputted to the A/D converter 91 and converted into digital signals. The digital signals are inputted into a storage circuit 93 and stored. The photoreception signal inputted to the A/D converter 91 are signals outputted from the amplifier 85 during a period between time t0 and time at which a predetermined time has elapsed since time t0, for instance 2000 ns. The A/D converter 91 divides the photoreception signal into N sections by a predetermined interval, for instance 10 ns and converts an average of the photoreception signal in each section into a digital value as shown in FIG. 5.

A summation range specification circuit 95 selects the predetermined numbers of the photoreception signals corresponding to the predetermined numbers of the laser beams emitted adjacent to each other in the X-axis direction from the photoreception signals stored in the storage circuit 93. Then, it inputs the selected photoreception signals to a summation circuit 97 connected in a subsequent stage.

FIG. 6 shows a laser beam emitting area and a relation between the vehicle and a vehicle 130 in front. Only a area of one scanning line is shown in FIG. 6 for brevity. The vehicle 130 has a reflector that has high reflecting intensity for laser beams on its rear surface. A body of the vehicle 130 also has relatively high reflecting intensity although the intensity is not as high as that of the reflector. Thus, the intensity of the reflected light from the vehicle 130 is high and the levels of the photoreception signals corresponding to the reflected light are higher than the reference voltage V0.

The intensity of the reflecting light from the vehicle 130 decreases if the rear surface of the vehicle 130 is covered with dirt or snow. As a result, the levels of the photoreception signals corresponding to the reflected light may not exceed the reference voltage V0. In such a case, the vehicle 130 cannot be detected based on the reception signals. The detection of the vehicle 130 becomes more difficult as the distance to the vehicle 130 increases.

To solve this problem, multiple photoreception signals are summed up to amplify the photoreception signal so that the reflected light having low intensity can be detected. The summation range specification circuit 95 specifies the photoreception signals to be summed.

The number N of the photoreception signals to be summed is preferably set based on a length W of an object in the side-to-side direction of the vehicle, a detection distance L0, and a beam step angle ,, of the laser beam in the side-to-side direction of the vehicle. Namely, the number N is determined in a condition that an emitting range of the predetermined number of outgoing waves corresponds to the length W at the detection distance L0. The number N is calculated by the following equation:
N=W/(L0×tan,,)
The photoreception signals to be summed are always selected from the photoreception signal outputted when the reflected light is received from the object in a distance range with a target detection distance L0 as an upper limit by setting the number N. In this case, only the photoreception signal including the photoreception signal components corresponding to the intensity of the reflected light are summed. Thus, the sensitivity in the reflected light detection based on the summation signal is efficiently improved.

In the example shown in FIG. 6, the number N is set to 16 because the width of the vehicle 130 is about 1.8 m, the detection distance L0 is 80 m, and the beam step angle is 0.08 degrees.

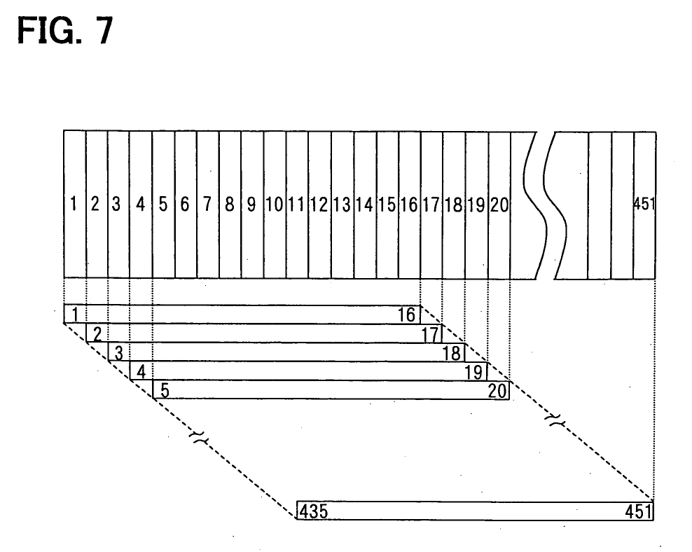

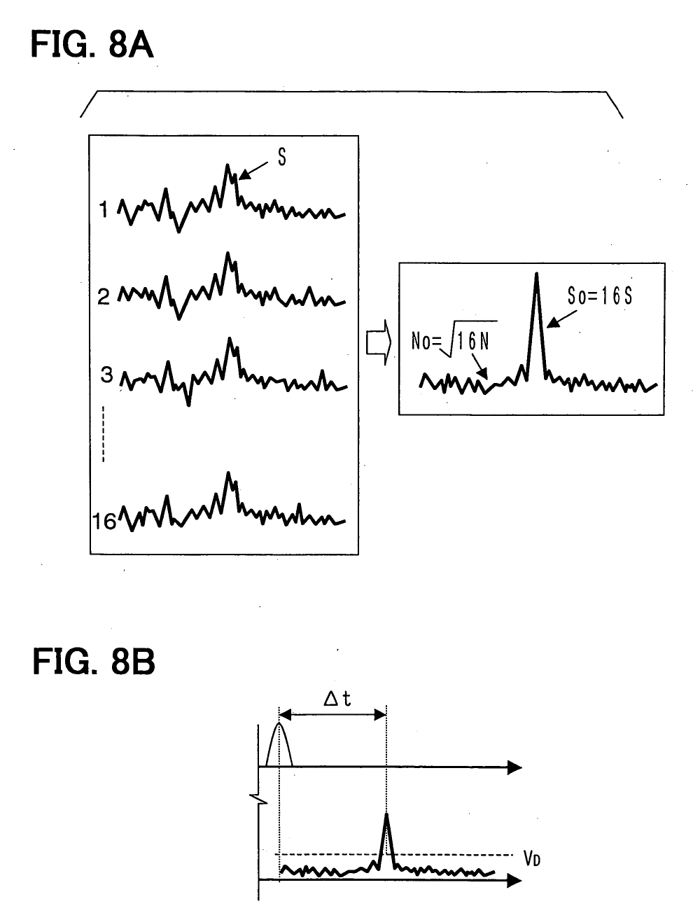

The summation range specification circuit 95 shifts the summation range at predetermined intervals. The intervals are determined based on a period in which the summation circuit 97 completes the summation of sixteen photoreception signals, a comparator 103 completes the comparison, a linear interpolation circuit 109 completes linear interpolation, and a time counting circuit 111 completes calculation of the time difference ,,t. If the laser beams are emitted 451 times for scanning from left to right and the reception signals are marked with the respective numbers as shown in FIG. 7, the summation range specification circuit 95 specifies the photoreception signals marked with numbers 1 through 16 for the summation range. The summation range specification circuit 95 shifts the summation range by one photoreception signal. With this configuration, the reduction in the angle resolution using the summation signal is less likely to occur while the summation of sixteen photoreception signals is performed.

If the photoreception signals outputted from the photoreceptor 82 are divided into groups of 16 and the summation of sixteen signals is performed for each group, the sensitivity of the reflected light detection can be improved. However, the angle resolution using the summation signal greatly reduces. With the above-described configuration, namely, shifting the summation range by one reception signal, the reduction in the angle resolution is less likely to occur.

The sixteen photoreception signals in the specified summation range are read out from the storage circuit 93 and inputted to the summation circuit 97. The summation circuit 97 sums up the sixteen photoreception signals, which are already converted into the digital signals. If all the sixteen signals contain photoreception signal components S corresponding to the reflected light from the same object, the photoreception signal components S appear after the same time has passed since the laser beam emitted time. Therefore, a photoreception signal component S0 of the summation signal has an amplitude sixteen times larger than the photoreception signal component S of each photoreception signal.

The noise component N of each photoreception signal is randomly produced due to extraneous light. The noise component N0 of the summation signal is only four times (“16) larger than the noise component N of each photoreception signal even when sixteen photoreception signals are summed up. Thus, a signal-to-noise ratio (S/N ratio) of the photoreception signal component S0 and the noise component N0 is four time better in the case the summation signal is calculated by the summation circuit 97. Namely, the object is properly detected based on the amplified photoreception signal component S0 even when the photoreception signal component S of each photoreception signal is small and difficult to distinguish from the noise component N.

A switching circuit 100 shown in FIG. 2C switches a destination of output signals from the summation circuit 97 between the comparator 103 and the background noise calculation circuit 99. The background noise calculation circuit 99 calculates a noise component included in the photoreception signal based on the summation signal outputted from the summation circuit 97 when select 2 is set in the selector 84. The distance detection is not performed and the output signal of the dummy circuit 83 amplified by the amplifier 85 is outputted when the select 2 is set.

The polygon mirror 73 is rotated and 451 lines of the laser beams are emitted toward the polygon mirror 73 such that the laser beams run in the X-axis and Y-axis directions for scanning after reflected off the polygon mirror 73. The distance detection is not performed during a period when the mirrors are switching according to the rotation of the polygon mirror 73. Select 2 is set in the selector 84 during the period and the switching circuit 100 switches the destination to the background noise calculation circuit 99.

In this case, the summation signal calculated by the summation circuit 97 is an output signal of the dummy circuit 83 and therefore the photoreception signal component S is not included in the summation signal. The impedance of the dummy circuit 83.1s determined at the same level as that of the photoreceptor 82. Thus, the dummy circuit 83 receives the same levels of electromagnetic noises that the photoreceptor receives and only the noise component included in the photoreception signal is included in the output signal. The summation signal is a sum of the noise components N. The S/N ratio of the summation signal is even improved by removing the nose components N from the summation signal.

It is preferable to emit the laser beams from the light emitting circuit 70a during the period that the distance detection is not performed because electromagnetic noises are produced during the emission of the laser beams and they may be included in the photoreception signals.

The summation circuit 97 outputs multiple summation signals when the scan area is not irradiated with the laser beams. The background noise calculation circuit 99 averages out the summation signals and produces an average summation signal through a simple averaging process or a weighted averaging process. Pattern noise components are observed characteristically in the average summation signal.

Some of the noise components included in the photoreception signals are produced in patterns according to clock pulses outputted from the CPU 70a or electromagnetic noises resulting from the emission of the laser beams. Such noise components become more distinguishable with respect to the random noise components as a repeat of the averaging process increases. The pattern noise components are always included in the summation signals. The pattern noise components are properly removed from the summation signals by calculating the noise components through the averaging process and removing the noise components from the summation signals.

A subtraction circuit 101 subtracts the noise component calculated by the background noise calculation circuit 99 from the summation signal outputted from the summation circuit 97 when the scan area is irradiated with the laser beams. The comparator 103 is a reception signal component determination section that determines whether the photoreception signal component is included in the photoreception signal. The summation signal from which the noise component is removed by the subtraction circuit 101 is inputted to the comparator 103. The comparator 103 compares the summation signal with a threshold Vd outputted from a threshold setting circuit 105. The threshold Vd corresponds to the threshold voltage V0.

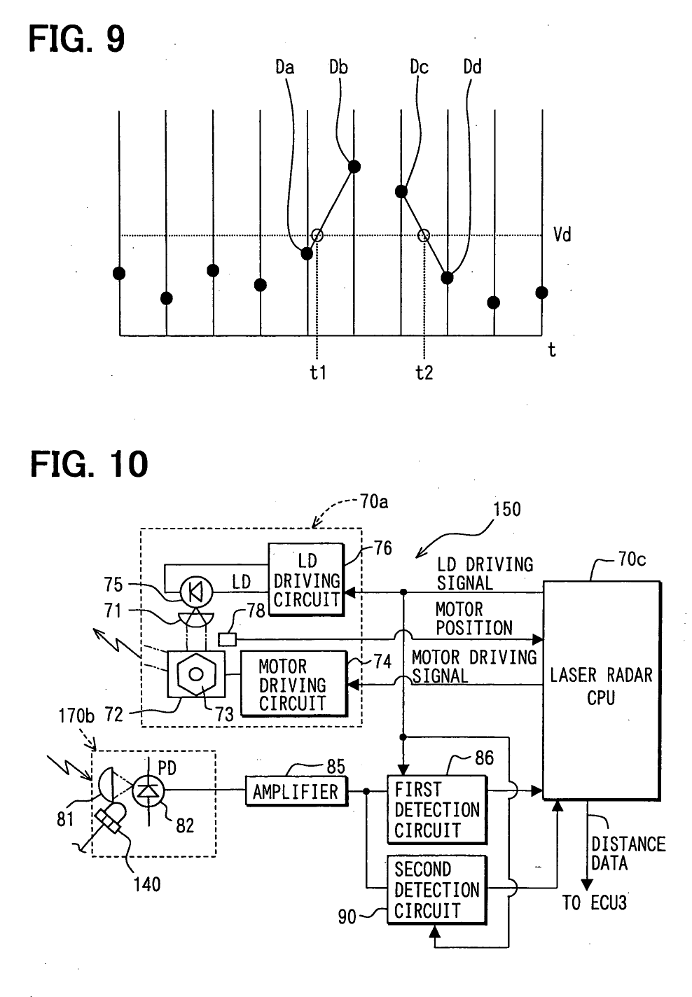

Digital values of the summation signals are discretely calculated at predetermined time intervals as shown in FIG. 9. Each digital value is compared with the threshold Vd. Results of the comparison are inputted to the linear interpolation circuit 109 when the digital values Db, Dc are larger than the threshold Vd.

The linear interpolation circuit 109 calculates the rising time t1 and the falling time t2, at which the summation signal curve is estimated to cross the threshold line, through linear interpolation. The digital value Db over the threshold Vd and the digital value Da immediately below the threshold Vd are connected with an imaginal line. The time at which the imaginal line crosses the threshold line is calculated and referred to as the rising time t1. The digital value Dc over the threshold Vd and the digital value Dd immediately below the threshold line are connected with an imaginal line. The time at which the imaginal line crosses the threshold line is calculated and referred to as the falling time t2. The digital values between the digital values of the summation signal are interpolated even when discrete digital values are provided at the predetermined intervals. The rising time t1 and the falling time t2 are calculated based on the time at which the imaginal line crosses the threshold line.

The time counting circuit 111 performs the same process as the time counting circuit 88. It calculates the time at which a peak appears in the photoreception signal component based on the rising time t1 and the falling time t2. It calculates the time difference ,,t between the time at which the laser beam is emitted and the time at which the peak appears in the photoreception signal component. Then, it inputs a signal indicating the time difference ,,t to the CPU 70c.

The CPU 70c calculates a distance to the object based on the time differences ,,t inputted from the time counting circuits 88, 111. It then produces position data based on the distance and the scan angles ,,x, ,,y. More specifically, it determines a center of the laser radar 5 as an origin (0, 0, 0) based on the distance and the scan angles ,,x, ,,y, and determines x, y, z coordinate data (position data) of the object, where the X-axis, Y-axis, and Z-axis are set in the side-to-side direction, the top-to-bottom direction, and the rear-to-front directions of the vehicle, respectively. It inputs the position data to the ECU 3 as distance measurement data. The scan angle ,,x is the scan angle ,,x of the laser beam at the center among the multiple laser beams corresponding photoreception signals of which are summed up.

The ECU 3 recognizes objects based on the distance measurement data inputted from the laser radar sensor 5. It outputs driving signals to the brake driving unit 19, the throttle driving unit 21, and the automatic transmission control unit 23 according to conditions of the vehicle in front determined based on the recognized objects. The speed of the vehicle is controlled, namely, adaptive cruise control is performed. The ECU 3 also performs a alarm generation determination process for producing an alarm when the recognized objects exist within a predetermined warning area for a predetermined period. The object includes a vehicle traveling or being parked ahead.

The configurations of the ECU 3 will be discussed. The distance measurement data outputted from the radar sensor 5 is passed to an object recognition block 43. The object recognition block 43 calculates a center position (X, Y, X) of the object and a size of the object (W, D, H) from a width W, a depth D, and a height H based on three dimensional data, which is the distance measurement data. It also calculates a relative speed (Vx, Vy, Vz) of the object with respect to the position of the vehicle based on a variation of the center position over the time. Furthermore, it determines whether the object is standing still or moving based on the vehicle speed outputted from the speed calculation block 47 and the relative speed. If the object is determines as an obstacle to the vehicle based on the above determination and the center position of the object, a distance to the object is displayed on the distance displaying unit 15.

A steering angle calculation block 49 calculates a steering angle based on a signal from the steering angle sensor 27. A yaw rate calculation block 51 calculates a yaw rate based on a signal from the yaw rate sensor 28. A curvature radius calculation block 57 calculates a curvature radius R based on the vehicle speed, the steering angle, and the yaw rate. The object recognition block 43 determines whether the object is possibly a vehicle and traveling in the same lane based on the curvature radius R and the center position (X, Z). The sensor error detection block 44 determines whether the data obtained in the object recognition block 43 is in an abnormal range. If the data is in the abnormal range, an error is indicated by the sensor error displaying unit 17.

A preceding vehicle detection block 53 detects a vehicle ahead based on the data from the object recognition block 43, and calculates a Z-axis distance Z to the vehicle ahead and a relative speed Vz of the vehicle ahead. The ECU 3 determines details of the cruise control based on the distance Z, the relative speed Vz, a setting condition of the cruise control switch 26, a condition of the brake switch 9, and sensitivity settings of the alarm sensitivity setting unit 25. Then, it outputs control signals to the automatic transmission control unit 23, the brake driving unit 19, and the throttle driving unit 21 for implementing necessary control.

An alarm generation determination block 55 determines whether generation of an alarm is required based on the distance Z, the relative speed Vz, a setting condition of the cruise control switch 26, a condition of the brake switch 9, and sensitivity settings of the alarm sensitivity setting unit 25. Then, it outputs an alarm generation signal to the alarm generating unit 13 if the alarm is required. A necessary display signal is outputted to the distance displaying unit 15 for notifying the driver of the conditions when the above controls are implemented.

In this embodiment, the photoreception signals outputted from the photoreceptor 82 and the output signals of the dummy circuit 83 are amplified by the amplifier 85 and inputted to the second detection circuit 90. The noise components included in the photoreception signals are detected based on the output signals of the dummy circuit 83. The distance detection is performed based on the signals produced by removing the noise components from the photoreception signals.

With this configuration, an object detectable distance range of the laser radar sensor 5 is less likely to be reduced. Moreover, the noise components are detected using the dummy circuit 83 and the selector 84. Thus, the consideration of the predetermined rotation angle is not required in optical system design unlike the prior art and limiting factors in the optical system design can be reduced.

### Second Embodiment

Referring to FIG. 10, a laser radar sensor 150 includes a light receiving circuit 170b. Other configurations are the same as the first embodiment, and therefore only the configuration of the light receiving circuit 170b will be discussed.

The light receiving circuit 170b does not include the dummy circuit 83 and the selector 84 that are included in the light receiving circuit 70b of the first embodiment. The photoreception signals outputted from the photoreceptor 82 are directly inputted to the amplifier 85. Furthermore, a light emitting device 140, for example, a light emitting diode, is arranged adjacent to the photoreceptor 82.

The light emitting device 140 emits light toward the photoreceptor 82 and the photoreceptor 82 is lighted with high intensity of light. Thus, the photoreceptor 82 can be saturated, and the photoreceptor 82 does not output signals in response to incident light when light is emitted from the light emitting device 140. Namely, the photoreception signal components are maintained at a saturated level.

The light emission of the light emitting device 140 is disabled during the distance detection so that the photoreception signals corresponding to intensity of the light received by the photoreceptor 82. The light emission of the light emitting device 140 is enabled when the distance detection is not performed so that the photoreception signal components are maintained at a constant level. The noise components are calculated by subtracting the constant photoreception signal components from the photoreception signals produced at the time when the distance detection is not performed. The noise components are calculated by the background noise calculation circuit 99. The noise components are removed from the photoreception signals and therefore the same effects as the first embodiment are provided.

The photoreceptor 82 may be lighted with sunlight when the distance detection is not performed so that the saturation is passively produced. In this case, shot noises may be increased. However, the shot noises do not affect to detection of stationary noises.

### Third Embodiment

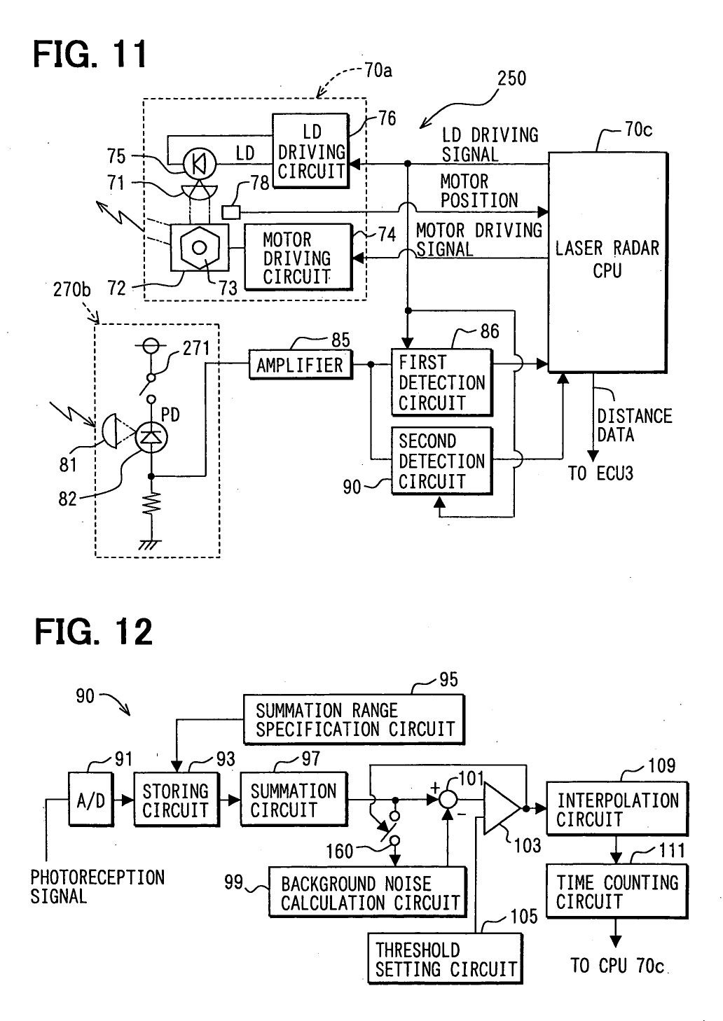

Referring to FIG. 11, a laser radar sensor 250 includes a light receiving circuit 270b. Other configurations are the same as the first embodiment, and therefore only the configuration of the light receiving circuit 270b will be discussed.

The light receiving circuit 270b does not include the dummy circuit 83 and the selector 84 that are included in the light receiving circuit 70b of the first embodiment. The photoreception signals outputted from the photoreceptor 82 are directly inputted to the amplifier 85. Furthermore, a switching device 271, for example, a transistor, is connected in a power supply line for feeding bias current to the photoreceptor 82.

The bias current supply to the photoreceptor 82 is controlled according to turning on and off of the switching device 271. Levels of the photoreception signals, namely, output voltages, corresponding intensity of incident light of the photoreceptor 82 greatly changes according to the bias current whether it is supplied. Waveforms of the reception signals become dull without bias current even when the photoreceptor 82 receives incident light.

The switching device 271 is turned on for supplying bias current to the photoreceptor 82 when the distance detection is performed. As a result, the photoreception signals having good response to the incident light are outputted from the photoreceptor 82. The switching device 271 is turned off for stopping supply of the bias current when the distance detection is not performed. As a result, the photoreception signals, the photoreception signal components of which are smaller in this case than the above case, are outputted from the photoreceptor 82. With this configuration, the noise components are calculated based on the waveforms of the photoreception signals produced when the distance detection is not performed. The noise components are calculated by the background noise calculation circuit 99. The noise components are removed from the photoreception signals and therefore the same effects as the first embodiment are provided.

### Fourth Embodiment

Light reflected off a cover glass may be enters into the photoreceptor 82 if such a cover glass is provided in front of the laser radar sensor 5. The reflected light components corresponding to the reflected light from the cove glass are considered as noises in the distance detection. Thus, the summation signals produced when the photoreception signal components are not included are inputted to the background noise calculation circuit 99. The background noise calculation circuit 99 learns the reflected light components as reflected light noises.

The reflected light noises changes according to the scanning direction and therefore the reflected light noise components are removed for each scanning direction. However, some hundreds of scanning angles exist and leaning the reflected light noises for each scanning angle is not practical because it requires a large size memory for the learning processes and the learning results.

The angle-dependency of the reflected light noises components is moderate. The angle-dependency does not greatly vary although the reflected light noise components vary according to surface conditions of the cover glass. The noises inside the laser radar sensor 5 do not have the angle-dependency. From the above reasons, the background noise calculation circuit 99 only learns the reflected light noise components at major points.

Referring to FIG. 12, the dummy circuit 83 and the selector 84 that are included in the light receiving circuit 70b of the first embodiment are not provided. The photoreception signals outputted from the photoreceptor 82 are directly inputted to the amplifier 85. Furthermore, a switching device 160 is provided for enabling or disabling an input of the photoreception signal to the background noise calculation circuit 99 according to results of the determination in which whether the photoreception signal component is included in the photoreception signal is determined.

The summation signals outputted from the summation circuit 97 are always inputted to the subtraction circuit 101. The switching device 160 is turned on when the summation signal from which the noise components are subtracted is smaller than the threshold voltage V0 and no photoreception signal components are determined. The summation signal is inputted to the background noise calculation circuit 99. The background noise calculation circuit 99 calculates the reflected light noise component based on the summation signal when no photoreception signal components are determined. The reflected light noise component corresponding to the scanning angle at that time is stored in a memory space.

Angle-dependency data of the reflected light noises is stored in the background noise calculation circuit 99. The reflected light noise components calculated based on the summation signals at the time when no photoreception signal components are determined are determined as the reflected light noises at major points. The reflected light noise component at each scanning angle is calculated based on the angle-dependency data of the reflected light noises and the reflected light noises at the major points.

It is determined that the photoreception signals at the time when no photoreception signal components are determined only include the reflected light noise components. The summation signal at that time is inputted to the background noise calculation circuit 99. Therefore, the reflected light noise components are properly calculated and the reflected light noise components are properly subtracted from the summation signal by the subtraction circuit 101.

The reflected light noise components are calculated only when no photoreception signal components are determined. The reflected light noise components are calculated based on the calculated reflected light noise components and the stored angle-dependency data of the reflected light noises for each scanning angle. The reflected light noise components are calculated for the scanning angles that are different from the angle at which the determination is made. With this configuration, learning of the reflected light noise components for each scanning angle is possible without requiring a large memory space for the learning process and the learning results.

A device for monitoring surface conditions of the cover glass and detecting variations in the conditions may be included in the laser radar sensor 5. Moreover, rain, fog, and snow sensors may be installed. The outputs of such devices can be inputted to the background noise calculation circuit 99 and used for the calculation of noise components.

The present invention should not be limited to the embodiment previously discussed and shown in the figures, but may be implemented in various ways without departing from the spirit of the invention. For example, the first through the fourth embodiments can be used in combination. A combination of the first, the second, or the third embodiments and the fourth embodiments provides a laser radar sensor that efficiently calculates internal and external noise components.

The CPU 70c or the first detection circuit 80 may be configured to output information for specifying the photoreception signals, such as signal numbers identifying the photoreception signals, when the amplitude of the photoreception signals is higher than the reference voltage V0. The summation range specification circuit 95 may be configured to receive the information and exclude the photoreception signals from the photoreception signals to be summed.

In the above embodiments, the summation of the photoreception signals is performed to detect an object even when each photoreception signal does not have intensity (amplitude) high enough for the object detection. Thus, the summation is not necessary if the photoreception signal has intensity high enough for the object detection. Moreover, the angle resolution can be improved when an object is detected based on each photoreception signal than the summation signal. Therefore, it is better to produce the distance measurement data on the object based on the detection result obtained from the detection based on each photoreception signal. Still moreover, the number of calculation steps can be reduced and calculation time can be reduced by excluding the photoreception signals from the photoreception signals to be summed,

The first and the second detection circuit may be configured as software. The process for calculating the distance L based on the time difference ,,t may be performed in a logic circuit formed by hardware.

The photoreception signals to be summed may be photoreception signals corresponding to the laser beams adjacent to each other in the Y-axis direction. The ranges of the laser beams may extend multiple scan lines in the X-axis or the Y-axis direction. A mechanism that can adjust angles of mirror faces using a galvanometer mirror may be used instead of the polygon mirror although the polygon mirror has an advantage of providing two-dimensional scanning only with rotary driving operation.

Electromagnetic waves, such as millimeter waves, or ultrasonic waves may be used instead of laser beams. Any methods other than the method using canning may be used for measuring a distance and directions. When a frequency modulated continuous wave (FMCW) radar or a Doppler radar are used as a millimeter wave radar, data on a distance to a vehicle in front and a relative speed of the vehicle in front is obtained at the same time. Therefore, the process of calculating the relative speed based on the distance is not required.

1. A radar device comprising:
outgoing wave emitting means that emits outgoing waves to a predetermined area;
reflected wave receiving means that receives reflected waves of the outgoing waves and outputs reception signals according to intensity of the reflected wave;
noise calculation means that calculates noise components included in the reception signals;
noise component removing means that removes the noise components from the reception signals; and
detection means that detects an object reflecting the outgoing waves based on at least one of the reception signals from which the noise components are removed by the noise component removing means, wherein
the reflected wave receiving means includes a reception signal output section, a noise component signal output section, and a selector section,
the reception signal output section outputs a reception signal including a reception signal component corresponding to the intensity of the reflected wave when the reflected wave is received,
the noise component signal output section outputs a noise component signal including only the noise component,
the selector section selects either one of the reception signal and the noise component signal as an input signal to the detection means,
the noise calculation means calculates the noise component based on the noise component signal when the noise component signal is selected by the selector section, and
the noise component removing means removes the noise component from the reception signal when the reception signal is selected by the selector section.

2. The radar device according to claim 1, wherein the noise component signal output section is a dummy circuit having a same level of impedance as that of the reception signal output section.

3. The radar device according to claim 1, wherein:
the detection means includes a summation section that sums up the reception signals selected by the selector section;
the noise calculation means calculates the noise component based on a summation signal corresponding to a sum of the reception signals; and
the noise component removing means removes the noise component from the summation signal.

4. The radar device according to claim 1, wherein:
the detection means includes a reception signal component determination section and a switching section;
the reception signal component determination section determines whether a reception signal component corresponding to the intensity of the reflected wave is included in the reception signal when the reflected wave is received; and
the switching section disables the input of the reception signal to the noise calculation section when the reception signal component determination section determines that the reception signal component is not included in the reception signal.

5. A radar device comprising:
outgoing wave emitting means that emits outgoing waves to a predetermined area;
reflected wave receiving means that receives reflected waves of the outgoing waves and outputs reception signals according to intensity of the reflected wave;
noise calculation means that calculates noise components included in the reception signals;
noise component removing means that removes the noise components from the reception signals; and
detection means that detects an object reflecting the outgoing waves based on at least one of the reception signals from which the noise components are removed by the noise component removing means, wherein
the reflected wave receiving means includes a reception signal output section and an electromagnetic wave output section,
the reception signal output section outputs a reception signal including a reception signal component corresponding to the intensity of the reflected wave when the reflected wave is received,
the electromagnetic wave output section outputs an electromagnetic wave that saturates the reception signal outputted from the reception signal output section,
the noise calculation section calculates the noise component based on the reception signal outputted when the electromagnetic wave is outputted, and
the noise component removing means removes the noise component from the reception signal outputted when the electromagnetic wave is not outputted.

6. The radar device according to claim 5, wherein:
the outgoing wave emitting means is a light emitting circuit that outputs light waves as outgoing waves;
the reflected wave receiving means is a light receiving circuit that receives reflected light waves of the light waves;
the reception signal output section is a photoreceptor that produces output signals corresponding to the intensity of the reflected light waves; and
the electromagnetic wave output section is a light emitting device that saturates an output signal of the photoreceptor.

7. A radar device comprising:
outgoing wave emitting means that emits outgoing waves to a predetermined area;
reflected wave receiving means that receives reflected waves of the outgoing waves and outputs reception signals according to intensity of the reflected wave;
noise calculation means that calculates noise components included in the reception signals;
noise component removing means that removes the noise components from the reception signals; and
detection means that detects an object reflecting the outgoing waves based on at least one of the reception signals from which the noise components are removed by the noise component removing means, wherein
the reflected wave receiving means includes a reception signal output section and a switching section,
the reception signal output section driven with power supplied from a power source outputs a reception signal including a reception signal component corresponding to the intensity of the reflected wave when the reflected wave is received,
the switching section turns on and off the power supply to the reception signal output section,
the noise calculation means calculates the noise component based on the reception signal outputted when the power supply to the reception signal output section is turned off by the switching section, and
the noise removing means the noise component from the reception signal outputted when the power supply to the reception signal output section is turned on by the switching section.

8. The radar device according to claim 7 wherein:
the detection means includes a reception signal component determination section and a switching section;
the reception signal component determination section determines whether a reception signal component corresponding to the intensity of the reflected wave is included in the reception signal when the reflected wave is received; and
the switching section disables the input of the reception signal to the noise calculation section when the reception signal component determination section determines that the reception signal component is not included in the reception signal.

9. The radar device according to claim 8, wherein:
the noise calculation means stores correlation data on a correlation between a reflected light noise and a scanning angle of the outgoing wave; and
the noise calculation means calculates the reflected light noise for each scanning angle including another scanning angle that is different from the scanning angle, at which the reception signal component determination section determines that no reception signal component is included in the reception signal, based on the reception signal produced at the scanning angle, the scanning angle, and the correlation data.

10. A radar device comprising:
outgoing wave emitting means that emits outgoing waves to a predetermined area;
reflected wave receiving means that receives reflected waves of the outgoing waves and outputs reception signals according to intensity of the reflected wave;
noise calculation means that calculates noise components included in the reception signals;
noise component removing means that removes the noise components from the reception signals; and
detection means that detects an object reflecting the outgoing waves based on at least one of the reception signals from which the noise components are removed by the noise component removing means, wherein
the reflected wave receiving means includes a reception signal component determination section and a switching section,
the reception signal component determination section determines whether a reception signal component corresponding to the intensity of the reflected wave is included in the reception signal when the reflected wave is received, and
the switching section disables the input of the reception signal to the noise calculation means when the reception signal component determination section determines that the reception signal component is not included in the reception signal.

11. The radar device according to claim 10, wherein:
the noise calculation means stores correlation data on a correlation between a reflected light noise and a scanning angle of the outgoing wave; and
the noise calculation means calculates the reflected light noise for each scanning angle including another scanning angle that is different from the scanning angle, at which the reception signal component determination section determines that no reception signal component is included in the reception signal, based on the reception signal produced at the scanning angle, the scanning angle, and the correlation data.
